(19) United States
(12) Patent Application Publication
(10) Pub. No.: US 2014/0351212 A1
(43) Pub. Date: Nov. 27, 2014

(54) METHOD AND APPARATUS FOR PROCESSING READING HISTORY

(71) Applicant: TENCENT TECHNOLOGY (SHENZHEN) COMPANY LIMITED, SHENZHEN CITY (CN)

(72) Inventor: Xiaodan LIN, Shenzhen City (CN)

(21) Appl. No.: 14/458,237

(22) Filed: Aug. 12, 2014

Related U.S. Application Data
(63) Continuation of application No. PCT/CN2013/088750, filed on Dec. 6, 2013.

(30) Foreign Application Priority Data
Apr. 15, 2013 (CN) 201310130101.6

(51) Int. Cl. G06F 17/30

(52) U.S. Cl. CPC G06F 17/30174
USPC 707/624; 707/803

(57) ABSTRACT

A method and apparatus for processing reading history is provided. The method includes receiving a reading history saving instruction, and acquiring an anchor position of a designated reading position of a current web page; generating an anchor link, based on the anchor position of the designated reading position; creating a reading history based on a title of the designated reading position and the anchor link, the created reading history includes at least the title of the designated reading position and the anchor link; and saving the created reading history. By saving the title of the designated reading position and the anchor link correspondingly, this application makes it convenient for the user to fast access the web page to which the anchor link is directed, locate the anchor position, thereby reducing the electric power consumption during the terminal device is accessing a particular web page.

### CROSS-REFERENCE TO RELATED APPLICATIONS

This application is a continuation application of International Application PCT/CN2013/088750, with an international filing date of Dec. 6, 2013, claiming the priority benefit of Chinese Patent Application No. 201310130101.6 filed on Apr. 15, 2013, the disclosures of which are both incorporated by reference herein in their entireties for all intended purposes.

### FIELD OF THE INVENTION

The disclosure relates to the network technology field, and more specifically, to a method and apparatus for processing reading history.

### BACKGROUND

With the development of the network technology, the networking functions are becoming more and more, and users' requirement for the network browsing is also increasing. To meet the browsing requirement of the users, typically, the browser client provides favorites for users to save links of web pages which the user is interested in while browsing web pages. When next time the same web page needs to be read, users just click the saved link of the web page and the web page will open directly. This prevents surfing on the Internet to find the web page for the user and improves web page browsing efficiency.

However, though the web pages of the links can be saved, the functionality of favorites cannot record current reading progress of the user, for example, the present paragraph or page, etc. So the user needs to browse from the top of the saved webpage link to locate the actual position of the last reading to continue. And this inconvenience will inevitably result in the increased time of the user's operation process, which will consume extra electric power. As for the terminals with limited electric power such as smart phones and tablets, this will reduce the battery life.

### SUMMARY OF THE INVENTION

In order to accomplish the precise location of user reading and reduce electric power consumption of the terminal devices, embodiments of the present disclosure provide a method and apparatus for processing reading history. The technical solutions are as follows:

In one aspect, the present disclosure provides a method for processing reading history, including:

receiving a reading history saving instruction, and acquiring an anchor position of a designated reading position of a current web page;

generating an anchor link, based on the anchor position of the designated reading position;

creating a reading history based on a title of the designated reading position and the anchor link, the created reading history includes at least the title of the designated reading position and the anchor link;

saving the created reading history.

In another aspect, an apparatus for processing reading history is provided, the apparatus including:

an anchor position acquisition module, configured to receive a reading history saving instruction, and acquire an anchor position of a designated reading position of a current web page;

a generation module, configured to generate an anchor link, based on the anchor position of the designated reading position;

a reading history creation module, configured to create a reading history based on a title of the designated reading position and the anchor link, the created reading history includes at least the title of the designated reading position and the anchor link;

a saving module, configured to save the created reading history.

According to the method and apparatus provided by the embodiments of the present disclosure for processing reading history, the anchor position of the designated reading position of the current web page is acquired by receiving the reading history saving instruction; an anchor link is generated based on the anchor position of the designated reading position; reading history is created based on the title of the designated reading position and the anchor link, the created reading history includes at least the title of the designated reading position and the anchor link; and the created reading history is saved. By saving the title of the designated reading position and the anchor link correspondingly, the technical solution provided by the embodiments of the present disclosure makes it convenient for the user to fast access the web page to which the anchor link is directed, and locate the anchor position, thereby reducing the electric power consumption during the terminal device is accessing the particular web page.

### DESCRIPTION OF THE DRAWINGS

To better illustrate the technical solution of embodiments of the present disclosure, brief introductions to the drawings that are used in the description of the embodiments will be given below. It is obvious that the drawings in the following description are merely for exemplary embodiments of the present disclosure, and that a person of ordinary skilled in the art may think of additional drawings based on these figures.

FIG. 1a is a flow diagram of a method for processing reading history provided by the embodiments of the disclosure;

FIG. 1b is a schematic diagram of a reading history management interface provided by the embodiments of the disclosure;

FIG. 2a is a flow diagram of a method for processing reading history provided by the embodiments of the disclosure;

FIG. 2b is another schematic diagram of a reading history management interface provided by the embodiments of the disclosure;

FIG. 2c is another schematic diagram of a reading history management interface provided by the embodiments of the disclosure;

FIG. 3 is an exemplary structure diagram of an apparatus for processing reading history provided by the embodiments of the disclosure;

FIG. 4 is an exemplary structure diagram of a terminal device provided by the embodiments of the disclosure.

### DETAILED DESCRIPTION

To better illustrate the purpose, technical solutions and advantages of the present disclosure, several embodiments of the disclosure will be described in detail below in conjunction with the accompanying drawings.

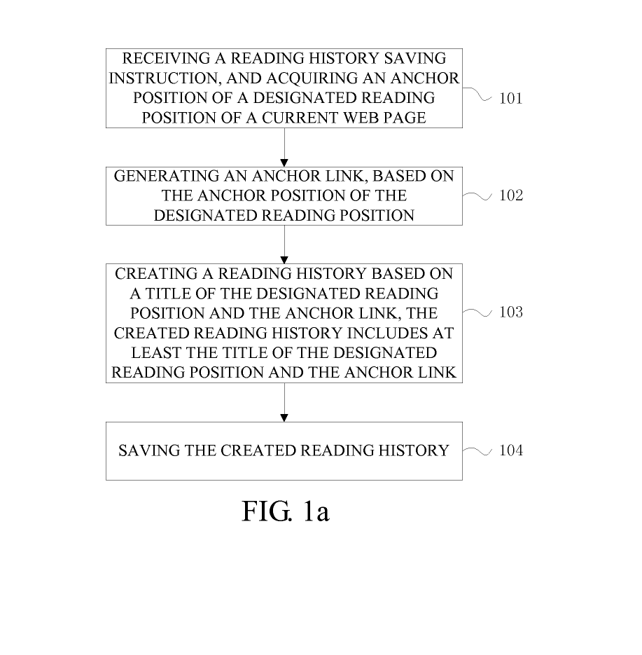

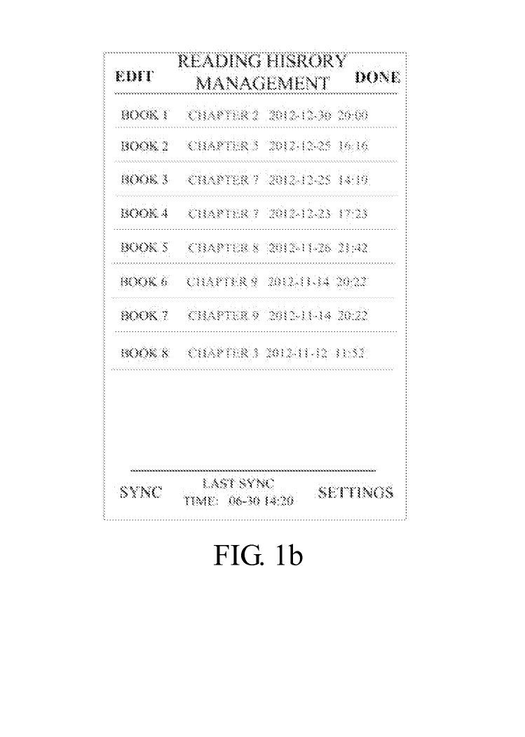

FIG. 1a is a flow diagram of a method for processing reading history provided by the embodiments of the disclosure. The execution subject of the embodiments of the present disclosure is a terminal device. Referring to FIG. 1a, the method includes:

101: receiving a reading history saving instruction, and acquiring an anchor position of a designated reading position of a current web page.

Wherein, the reading history saving instruction is an instruction for saving a reading history. The triggering of the reading history saving instruction may be implemented in any one of the following ways: (1) When the user wants to save, the user clicks on the save option to trigger the reading history saving instruction, for example, when the user is currently reading a certain chapter of a web page, by clicking the position of the title of the certain chapter, a dialog box will pop up. The dialog box contains operation to the chapter, such as “Copy”, “Paste”, “Saving as reading history”, etc. And by clicking the “Saving as reading history” option, the user triggers the reading history saving instruction. (2) When the browser is closed, the reading history saving instruction will be triggered. For example, when the user is reading in the application browser, the browser is suddenly closed due to an error, and then the reading history saving instruction will be triggered.

Wherein, the designated reading position may be the position that the cursor is currently located, the top of the page, etc. As for the web pages of online reading type, the designated reading position preferably is the first paragraph of the currently displayed web page, the chapter that contains the first paragraph, or the page number of the currently displayed web page, etc. And the anchor position may be the paragraph number, chapter number, page number and so on.

In this embodiment of the disclosure, after receiving the reading history saving instruction triggered by the user, the terminal device will acquire the position of the cursor in the current page or the position of the first paragraph of the currently displayed page as the anchor position of the designated reading position of the current page.

102: generating an anchor link, based on the anchor position of the designated reading position.

Wherein, the anchor link is directed to a specific document, chapter or paragraph. When the anchor link is triggered, it can quickly jump to a corresponding position of the web page corresponding to the anchor link.

Based on the anchor position of the designated reading position, the terminal device generates an anchor link to the anchor position. So, the user can quickly locate to the anchor position in the web page corresponding to the anchor link via the anchor link.

103: creating a reading history based on a title of the designated reading position and the anchor link, the created reading history includes at least the title of the designated reading position and the anchor link.

Wherein the title of the designated reading position may include the page name, and may also include page number, chapter and paragraph, etc. The item contents contained in the title of the anchor position may be the default settings of the terminal device, or set by the user himself, the embodiment of the disclosure will not define this in detail.

Besides, the local reading history may be stored in the form of entries, each reading history includes the anchor link and the title of the designated reading position saved by the user. The user may add or delete the local reading history stored in the terminal device; the embodiment of the disclosure will not define this in detail. Preferably, for the user's convenience, each reading history also may include the creation time, editing time, etc., of the reading history.

104: saving the created reading history.

The anchor link and title of the anchor position of the current reading are saved correspondingly as the local reading history by the terminal device; otherwise, the anchor link and title of the anchor position of the current reading are displayed correspondingly on the screen of the terminal device, and after receiving user's instruction for confirming the saving, the terminal device saves the anchor link and title of the anchor position of the current reading as the local reading history. Of course, the reading history can be saved non-locally. For example, for cloud reading in which the reading contents and reading history are saved in the cloud (server), the contents displayed at the terminal are all saved in the cloud (for example, due to copyright protection, the contents cannot be downloaded to the terminal). Under this circumstance, saving the reading history in the cloud is enough, the reading history does not need to be saved locally.

FIG. 1b is a schematic diagram of a reading history management interface provided by the embodiments of the disclosure. Referring to FIG. 1b, the reading history management interface may include multiple reading histories sorted in chronological order by their creation time. Options such as editing, synchronizing, settings and done may be provided in this reading history management interface, for the user to manage the reading histories. Preferably, last sync time may also be provided in the reading history management interface, such that the user can determine whether it is necessary to synchronize the reading histories on this terminal device on the basis of the last sync time.

According to the method provided by this embodiment of the present disclosure for processing reading history, the anchor position of designated reading position of the current web page is acquired by receiving reading history saving instruction; an anchor link is generated, based on the anchor position of the designated reading position; a reading history is created based on a title of the designated reading position and the anchor link, the created reading history includes at least the title of the designated reading position and the anchor link; and the created reading history is saved. By saving the title of the designated reading position and the anchor link correspondingly, the technical solution provided by the embodiments of the present disclosure makes it convenient for the user to fast access the web page to which the anchor link is directed, and locate the anchor position, thereby reducing the electric power consumption during the terminal device is accessing the particular web page.

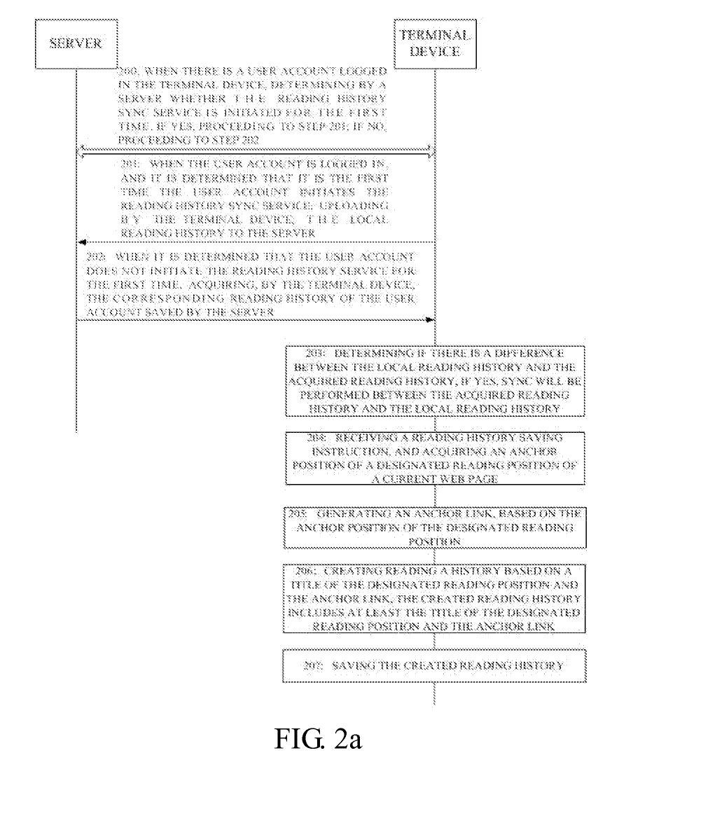

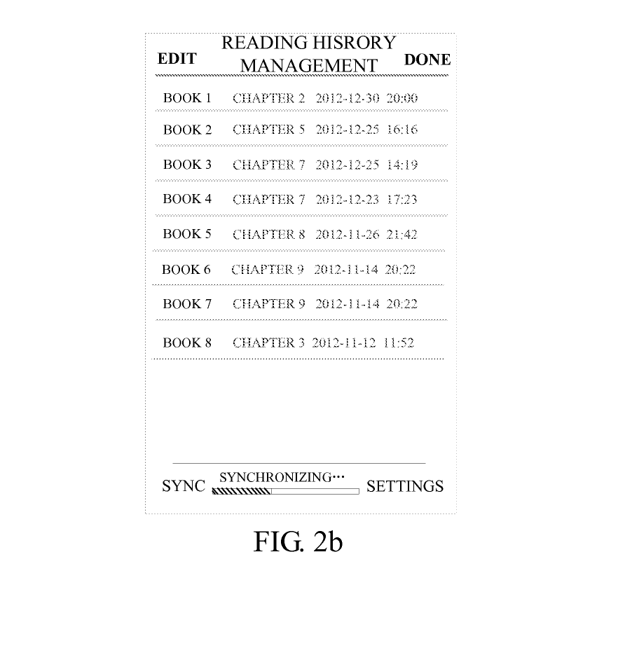

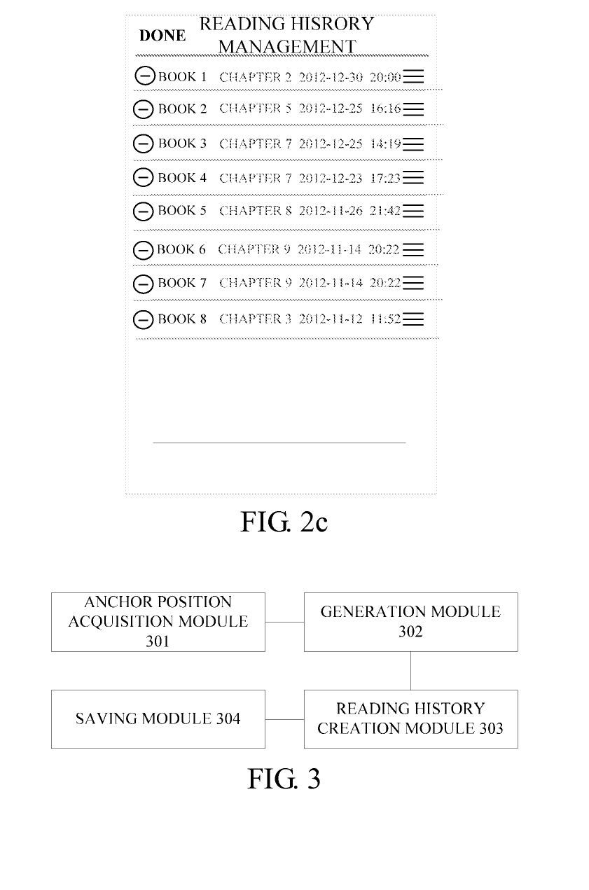

FIG. 2a is a flow diagram of a method for processing reading history provided by the embodiments of the disclosure. The execution subject of the embodiments of the present disclosure is a terminal device. Referring to FIG. 2a, the method includes:

200: when a user account is logged in at the terminal device, a server determines whether reading history sync service is initiated by the user account for the first time. If YES, it is proceeded to step 201; if NO, it is proceeded to step 202.

In this embodiment of the disclosure, the user may use a user account to log in the server by a terminal device with network connectivity. When the server determines that the user account initiates the reading history sync service for the first time, the server assigns corresponding storage space for this user account to store reading history. If the server determines that the user account does not initiate the reading history sync service for the first time, subsequent sync process is executed according to the reading history saved by the server and the local reading history saved by the terminal device. It is to be noted that the server may determine if it is the first time that the user account initiates the reading history sync service, based on whether this user account has a reading history sync service identifier. If the user account has a reading history sync service identifier, the user account does not initiate the reading history sync service for the first time; and if the user account does not have a reading history sync service identifier, it is the first time that the user account initiates the reading history sync service.

It is appreciated by a person skilled in the art that the status of the user account being logged in means the user uses the user name and corresponding password to log in the server by the terminal.

201: when a user account is logged in, and it is determined that it is the first time that the user account initiates the reading history sync service, the terminal device may upload the local reading history to the server.

When it is the first time that the user account initiates the reading history sync service, there is not any reading history about this user account on the server, the local reading history will be uploaded to the server when there is locally saved reading history at the terminal device, such that this reading history can be saved in the server for subsequent sync process.

202: when it is determined that the user account does not initiate the reading history sync service for the first time, the terminal device may acquire the corresponding reading history of the user account saved by the server.

More specifically, this acquisition process may include: the terminal device sending a reading history acquisition request to the server, upon receiving this reading history acquisition request, the server sending the reading history corresponding to the user account to the terminal device according to the user account, or the server sending the reading history corresponding to the user account to the terminal device.

It is to be noted that the same terminal device can be used for different user accounts to log in, and the same user account can be logged in at different terminal devices. When the user account is logged at a different terminal devices, the reading history stored in other terminal devices can be synchronized to this different terminal device, thereby achieving the sharing of user's reading history at multiple terminal devices, this avoids the repetition of searching reading history due to terminal device replacement, and also prevents the lost of the reading progress.

203: determining whether there is a difference based on the local reading history and the acquired reading history, if YES, the sync is executed based on the acquired reading history and the local reading history.

More specifically, determining whether there is a difference between the local reading history and the acquired reading history includes: determining whether there is any reading history with different title or anchor link between the local reading history and the acquired reading history. If there is a reading history with different title or anchor link, the local reading history and the acquired reading history are discrepant; otherwise, the local reading history is the same as the acquired reading history.

Specifically, the executed sync based on the acquired reading history and the local reading history may include: (1) if the different reading history is located at the local reading history, merging the different reading history and the acquired reading history, and uploading the merged reading history to the server; (2) if the different reading history is located at the acquired reading history, merging the different reading history and the local reading history. It is to be noted that, the merging in the embodiment of the disclosure refers to adding the different reading history to the acquired reading history or the local reading history.

Besides, if the local reading history is the same as the acquired reading history, the reading history may not be processed.

Alternatively, whether the local reading history includes a modification operation to any one of reading histories is determined. If YES, the modification operation will be synchronized to the corresponding reading history of the server.

Wherein, the modification operation may be deleting or editing an existed reading history, those operations are not specifically limited by the embodiment of the disclosure.

Correspondingly, the synchronization of the modification operation to the corresponding reading history in the server includes: the terminal device sending a modification request to the server in accordance with user's modification operation of the saved reading history on the reading history management interface of the terminal device, wherein the modification request has the operation type, operation object and corresponding modification content of the modification operation. The server synchronizes the modification content corresponding to the operation object based on the operation type of the modification operation, when receiving the modification request. More specifically, if the operation type of the modification operation is deleting operation, the server searches corresponding reading history on the server according to the modification object of the modification operation. When the reading history corresponding to the modification object is found, the reading history is deleted. If the operation type of the modification operation is adding operation, the modification content would be added to the reading history corresponding to the modification object on the server, in order to synchronize the corresponding reading history on the server with the local reading history.

The above steps 200-203 illustrate a process of synchronizing local reading history based on the acquired reading history. The above steps 200-203 may be executed during the user logs in at the terminal device with user account. And this process may be executed at the time of logging in, and may also be executed when the terminal device sends a sync request to the server. The detailed execution time only relates to the time of logging in or the time of sending sync request by the user, and in terms of time, it has no relationship with whether the user has actually read.

204: receiving the reading history saving instruction, and acquiring an anchor position of the designated reading position of the current web page.

Upon receiving the reading history saving instruction triggered by the user, the terminal device acquires the anchor position based on the position that the cursor is currently located or the top of the page. For example, the web page currently being viewed by the user is “XXXXX”, and when the user locates the cursor at the beginning of the fifth paragraph of the currently viewed page, by clicking the saving reading history option, the reading history saving instruction will be triggered. Upon receiving reading history saving instruction, the terminal device acquires the anchor position of the current reading (i.e., beginning of the fifth paragraph of the current reading page) based on the position that the cursor is currently located.

205: generating an anchor link, based on the anchor position of the designated reading position.

Step 205 is same as step 102, and thus will not be repeated herein.

206: creating a reading history based on a title of the designated reading position and the anchor link, the created reading history includes at least the title of the designated reading position and the anchor link.

The terminal device acquires a title of the designated reading position according to the content at the anchor position or the information input by the user. For example, if the terminal device displays a book being read, the title of the designated reading position may be the name of the book.

As for each reading history, only the title of the designated reading position is displayed on the screen of the terminal device, the anchor link is not displayed. When the user selects the title of the designated reading position, the anchor position will be located by the anchor link, i.e., the user can continue reading according to the reading history.

207: saving the created reading history.

Reading histories may be saved in the order of creation time, and may also be saved in sequence for those have the same title. For example, for a book titled “BOOK 1”, if local reading history has saved a reading history “BOOK 1, Chapter 3, Nov. 5, 2012”, and the newly created reading history is “BOOK 1, Chapter 4, Nov. 7, 2012”, this newly created reading history may be displayed under the reading history titled as “BOOK 1”.

Furthermore, when the terminal device saves the reading history created by the user, it may directly upload the created reading history to the server, such that the server may add the created reading history to the reading histories corresponding to the user account, to synchronize the reading history corresponding to user account in the server with the reading history of the terminal device, upon receiving the created reading history. Certainly, this sync may also be triggered by the terminal device sending sync request to the server.

FIG. 2b is a schematic diagram of a reading history management interface provided by the embodiments of the disclosure. Referring to FIG. 2b, this interface may record the reading histories of the user; each reading history may include a title, reading progress and creation time. For example, the title is “BOOK 1”, the reading progress is “Chapter 2”, and the saving time is “2012-12-30 20:00”. This figure provides a sync process of the reading history, a sync progress bar under FIG. 2b can be used to display that synchronization is performed and whether the synchronization is finished can be displayed by the sync progress bar.

FIG. 2c is a schematic diagram of another reading history management interface provided by the embodiments of the disclosure. Referring to FIG. 2c, editing option is provided in this reading history management interface, the user may perform modification operation (deleting, editing, etc.) to each reading history in the reading history interface using the editing option.

According to the method provided by this embodiment of the present disclosure for processing reading history, the anchor position of designated reading position of the current web page is acquired by receiving reading history saving instruction; an anchor link is generated, based on the anchor position of the designated reading position; reading history is created based on a title of the designated reading position and the anchor link, the created reading history includes at least the title of the designated reading position and the anchor link; and the created reading history is saved. By saving the title of the designated reading position and the anchor link correspondingly, the technical solution provided by the embodiments of the present disclosure makes it convenient for the user to fast access the web page to which the anchor link is directed according to the local reading history, locate the anchor position, thereby simplifying the operation complexity of repeatedly accessing each website to find the reading history due to restarting the system of a single terminal device, and reducing the electric power consumption during the terminal device is accessing a particular web page. Furthermore, this embodiment of the disclosure synchronizes the reading histories of the terminal device and the server by using the user account, accordingly, the backup of the reading history of a single terminal device can be achieved, and also the sharing and synchronization of reading histories of different terminal devices and different platforms can be achieved. Thus, the problem of sharing reading histories at multiple terminal devices is solved, and problem of lost local history due to the recovery or re-installing of the software is also solved.

FIG. 3 is an exemplary structure diagram of an apparatus for processing reading history provided by the embodiments of the disclosure. Referring to FIG. 3, the apparatus including:

an anchor position acquisition module 301, configured to receive a reading history saving instruction, and acquire an anchor position of a designated reading position of a current web page;

a generation module 302, configured to generate an anchor link, based on the anchor position of the designated reading position;

a reading history creation module 303, configured to create a reading history based on a title of the designated reading position and the anchor link, the created reading history includes at least the title of the designated reading position and the anchor link; and

a saving module 304, configured to save the created reading history.

Alternatively, the apparatus may include:

a first uploading module, configured to upload a created reading history to the server, such that the server performs synchronization based on the received reading history, when a user account is logged in.

Alternatively, the apparatus may also include:

a second uploading module, configured to upload the local reading history to the server, when a user account is logged in and it is determined that the user account initiates the reading history sync service for the first time;

an acquisition module, configured to acquire the corresponding reading history of the user account saved by the server, when a user account is logged in and it is determined that the user account does not initiate the reading history sync service for the first time; and

a synchronization module, configured to perform synchronization based on the acquired reading history corresponding to the user account and the local reading history.

Alternatively, the synchronization module may include:

a determination unit, configured to determine whether there is a difference based on the local reading history and the acquired reading history; and

a synchronization unit, configured to perform synchronization based on the acquired reading history and the local reading history, when the determination unit determines that there is a difference between the local reading history and the acquired reading history.

Alternatively, the synchronization unit is configured to merge the different reading history and the acquired reading history and upload the merged reading history to the server, when the different reading history is located at the local reading history;

the synchronization unit is also configured to merge the different reading history and the local reading history, when the different reading history is located at the local reading history.

Alternatively, the synchronization unit is also configured to determine whether the local reading history includes a modification operation to any one of reading histories, if YES, the modification operation will be synchronized to the corresponding reading history of the server.

According to the apparatus provided by this embodiment of the present disclosure for processing reading history, the anchor position of a designated reading position of the current web page is acquired by receiving a reading history saving instruction; an anchor link is generated, based on the anchor position of the designated reading position; a reading history is created based on a title of the designated reading position and the anchor link, the created reading history includes at least the title of the designated reading position and the anchor link; and the created reading history is saved. By saving the title of the designated reading position and the anchor link correspondingly, the technical solution provided by the embodiments of the present disclosure makes it convenient for the user to fast access the web page to which the anchor link is directed according to the local reading history, locate the anchor position, thereby simplifying the operation complexity of repeatedly accessing each website to find the reading history due to restarting the system of a single terminal device, and reducing the electric power consumption during the terminal device is accessing a particular web page.

It should be noted that when the apparatus for processing reading history in the above-mentioned embodiment processes a reading history, illustration is made according to the division of the above-mentioned functional modules, and in practical application, the above-mentioned functions can be assigned to be performed by different functional modules as needed, i.e., dividing the internal structure of the device into different functional modules to perform all or some of the above-described functions. In addition, the apparatus for processing reading history and the method for processing reading history provided by the above-mentioned embodiments belong to the same concept, and its specific implementation process is described in the method embodiment, which will not be repeated here.

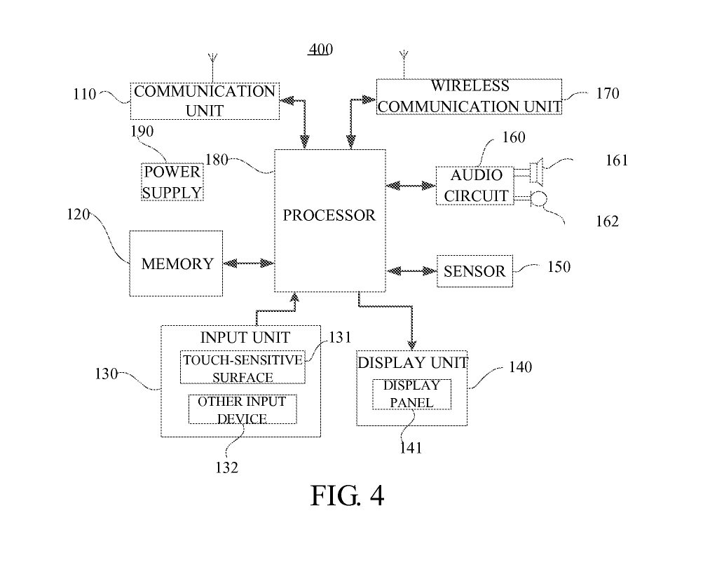

FIG. 4 is an exemplary structure diagram of a terminal device provided by the embodiments of the disclosure. Referring to FIG. 4, the terminal device may be used to implement the method for processing reading history provided by the above-mentioned embodiments, more specifically:

A terminal device 400 may include components such as a communication unit 110, a memory 120 containing at least one computer readable storage medium, an input unit 130, a display unit 140, a sensor 150, an audio circuitry 160, a Wi-Fi module 170, a processor 180 containing at least one processing core, a power supply 190 and so on. As appreciated by a person skilled in the art, the structure of the terminal device shown in FIG. 4 is not a limitation to the terminal device, the terminal device may contain components more than or less than that shown in the figure, some components may be combined or be arranged as different components, wherein,

The communication unit 110 is configured to receive and send signals during the process of communicating. The communication unit 110 may be a network communication device such as a Radio Frequency (RF) circuit, a router, a modem, and so on. More specifically, when the communication unit 110 is a RF circuit, the communication unit 110 receives the downlink information of the base station and forwards it to the at least one processor 180 to process; and the communication unit 110 sends the data relates to the uplink transmission to the base station. Typically, the RF circuit as the communication unit may include, but not limited to, antenna, at least one amplifier, resonator, one or more oscillators, Subscriber Identity Module (SIM) card, transceiver, coupler, Low Noise Amplifier (LNA), duplexer, and so on. In addition, the communication unit 110 may communicate with the network and other devices via wireless communication. The wireless communication may apply any one of the communication standards or protocols, which include but not limited to, Global System of Mobile communication (GSM), General Packet Radio Service (GPRS), Code Division Multiple Access (CDMA), Wideband Code Division Multiple Access (WCDMA), Long Term Evolution (LTE), email, Short Messaging Service (SMS), etc. Memory 120 may be used for storing software programs and modules. Processor 180 executes a variety of functional applications and data processing by running the software programs and modules stored in memory 120. Memory 120 may mainly contain a program storage area and a data storage area, wherein, the program storage area may store operating system, application needed for realizing at least one function (e.g., sound play function, image display function, etc.); and the data storage area may store the data created in accordance with the using of the terminal device 400 (e.g., audio data, telephone book, etc.). Besides, memory 120 may include high-speed Random Access Memory (RAM), and may include non-volatile memory, such as at least one magnetic disk storage device, flash memory device, or other non-volatile solid state storage device. Correspondingly, memory 120 may also include a controller of the memory for providing access to memory 120 of processor 180 and input unit 130.

Input unit 130 may be used for receiving input data or character information, and generating signal input from keyboard, mouse, joystick, optic or trackball that relate to user settings and function control. Specifically, the input unit 130 may include a touch-sensitive surface 131 and other input device 132. Touch-sensitive surface 131, also called as touch screen or touch panel, may collect touch operations performed on or near the touch-sensitive surface by the user (for example, a user uses any suitable object or attachment (such as a finger, a stylus, etc.) to operate on or near the touch-sensitive surface 131), and drive corresponding connection devices based on a predefined program. Alternatively, the touch-sensitive surface 131 may include a touch detection device and a touch controller. Wherein, the touch detection device detects user's touch position, identify a signal from the touch operation, and forward this signal to the touch controller; the touch controller receives touch information from the touch detection device, transforms it to coordinates of the touch point and forwards it to processor 180, and receives and executes instructions from processor 180. Besides, the touch-sensitive surface 131 may be implemented by various types of screens, such as resistive screen, capacitive screen, infrared screen and surface acoustic wave screen. In addition to the touch-sensitive surface 131, input unit 130 may also include other input devices 132. Specifically, other input devices 132 may include, but not limited to, a physical keyboard, functional keys (such as volume control buttons, switch buttons, etc.), a trackball, a mouse, a joystick, etc, or the combination thereof.

Display unit 140 may be used for displaying information input from the user, information that is provided to the user, and a variety of Graphic User Interfaces (GUIs) of the terminal device 400 which may be constituted by graphics, texts, icons, videos and any combination thereof. The display unit 140 may include a display panel 141 which can be optionally implemented by various forms, like Liquid Crystal Display (LCD), Organic Light-Emitting Diode (OLED), etc. Furthermore, touch-sensitive surface 131 may cover display panel 141. When a touch operation has been detected by the touch-sensitive surface 131, the touch operation is transmitted to processor 180 to determine the type of this touch event, then processor 180 provides corresponding visual output on the display panel 141 based on the type of the touch event. Though it is shown in FIG. 5 that the touch-sensitive surface 131 and display panel 141 are two separated components that implement the input and output functions respectively, but in some embodiments, the touch-sensitive surface 131 and display panel 141 can be integrated to implement the input and output functions.

The terminal device 400 may also include at least one type of sensor 150 which may be optical sensor, motion sensor and other sensors. Specifically, the optical sensor may include ambient light sensor and proximity sensor, wherein the ambient light sensor may adjust the brightness of the display panel 141 based on the brightness of the ambient light, and the proximity sensor may turn off display panel 141 and/or its backlight when the terminal device 400 approaches user's ears. As one kind of motion sensors, the gravity accelerometer may detect the acceleration in each direction (usually 3-axis) and the weight and direction of the gravity when static. These sensors may be used for the application of identifying phone's gesture (for example, rotation switch, related games, the correction of gestures of the magnetometer), functions related to vibration recognition (e.g., pedometer, click), etc. Other sensors that can be configured in terminal device 400 such as gyroscope, barometer, hygrometer, thermometer, infrared sensor will not be repeated herein.

Audio circuit 160, speaker 161, microphone 162 may be used to provide audio interfaces between the user and terminal device 400. Audio circuit 160 may receive audio data, transform it to electric signal, and transmit to the speaker 161 where the electric signal will be transformed to sound signal to output. Also, microphone 162 will transform the collected sound signal to electric signal, the electric signal is transformed to audio data after received by audio circuit 160, and then the audio data is sent to for example another terminal device for example, via RF circuit 110, or stored in memory 120 for further processing, after processed by processor 180. Also, audio circuit 160 may include earplug jack to support the communication between the peripheral headphones and terminal device 400.

In order to realize wireless communication, a wireless communication unit 170 may be configured in this terminal device. The wireless communication unit 170 may be a Wi-Fi module. Terminal device 400 may provide wireless broadband internet accessing to users, so users can email, browse web pages, and access streaming media etc. Though the wireless communication unit 170 is shown in FIG. 5, it can be understood that this unit can be omitted if necessary, as it is not an essential component of terminal device 400.

Processor 180 is the controlling center of terminal device 400, which communicates with other components of terminal device 400 via a variety of interfaces and lines. Processor 180 executes various functions of the terminal device 400 and processes data to control the overall mobile phone, by running software programs and/or modules stored in memory 120 and calling data stored in memory 120. Alternatively, processor 180 may include one or more processing cores. Preferably, an application processor and a modem processor may be integrated in processor 180, wherein the application processor is responsible for handling the operation system, user interface and application programs, etc., and the modem processor is mainly responsible for processing wireless communication. It is appreciated that the modem processor may also be separated from processor 180.

Terminal device 400 may also include power supply 190 (battery, for example) to supply power to each component. Preferably, the power supply may be logically connected to processor 180 via a power management system, and thus achieve functions such as charging, discharging and power consumption management via the power management system. Power supply 190 may also include any combination of components such as DC or AC power supply, recharging system, failing detection circuit of the power supply, power transformer or inverter, power status indicator, etc.

Terminal device 400 may also include a camera and a Bluetooth module etc., these components will not be described herein.

More specifically, in this embodiment, the display unit of the terminal device is a touch screen display; the terminal device may also include a memory, one or more programs stored in the memory, and one or more processors being configured to execute the one or more programs which have instructions to execute the following operations:

receiving a reading history saving instruction, and acquiring an anchor position of a designated reading position of a current web page;

generating an anchor link, based on the anchor position of the designated reading position;

creating a reading history based on a title of the designated reading position and the anchor link, the created reading history includes at least the title of the designated reading position and the anchor link;

saving the created reading history.

The above-mentioned embodiment is the first possible embodiment, in a second possible embodiment based on the first possible embodiment, the memory of the terminal device may also contain instructions to execute the following operations:

uploading a created reading history to the server such that the server performs synchronization based on the received reading history, when a user account is logged in.

And in a third possible embodiment based on the first possible embodiment, the memory of the terminal device may also contain instructions to execute the following operations:

uploading the local reading history to the server, when the user account is logged in and it is determined that the user account initiates the reading history sync service for the first time;

acquiring the corresponding reading history of the user account saved by the server, when it is determined that the user account does not initiate the reading history sync service for the first time;

performing synchronization based on the acquired reading history corresponding to the user account and the local reading history.

In a fourth possible embodiment based on the first possible embodiment, the memory of the terminal device may also contain instructions to execute the following operations:

determining whether there is a difference between the local reading history and the acquired reading history, if YES, synchronization will be performed based on the acquired reading history and the local reading history.

In a fifth possible embodiment based on any one of the foregoing possible embodiments, the memory of the terminal device may also contain instructions to execute the following operations:

merging the different reading history and the acquired reading history, and uploading the merged reading history to the server, when the different reading history is located at the local reading history;

merging the different reading history and the local reading history, when the different reading history is located at the local reading history.

In a sixth possible embodiment based on any one of the foregoing possible embodiments, the memory of the terminal device may also contain instructions to execute the following operations:

determining whether the local reading history includes a modification operation to the reading history, if YES, the modification operation will be synchronized to the corresponding reading history of the server.

As another aspect of the disclosure, another embodiment provides a computer readable storage medium. The computer readable storage medium may be computer readable storage medium stored in the above-mentioned memory, or a component external to the terminal device. The computer readable storage medium has stored one or more programs which are executed by one or more processors to perform a method for processing reading history, the method including:

receiving a reading history saving instruction, and acquiring an anchor position of a designated reading position of a current web page;

generating an anchor link, based on the anchor position of the designated reading position;

creating a reading history based on a title of the designated reading position and the anchor link, the created reading history includes at least the title of the designated reading position and the anchor link;

saving the created reading history.

The above-mentioned embodiment is the first possible embodiment, in a second possible embodiment based on the first possible embodiment, after the process of creating a reading history based on a title of the designated reading position and the anchor link, wherein the created reading history includes at least the title of the designated reading position and the anchor link, the method further includes:

uploading the created reading history to the server such that the server performs synchronization based on the received reading history, when a user account is logged in.

And in a third possible embodiment based on the first possible embodiment, before receiving reading history saving instruction, the method further includes:

uploading the local reading history to the server, when a user account is logged in and it is determined that the user account initiates the reading history sync service for the first time;

acquiring the corresponding reading history of the user account saved by the server, when it is determined that the user account does not initiate the reading history sync service for the first time;

performing synchronization based on the acquired reading history corresponding to the user account and the local reading history.

In a fourth possible embodiment based on the first possible embodiment, the synchronization based on the acquired reading history corresponding to the user account and the local reading history includes:

determining whether there is a difference between the local reading history and the acquired reading history, if YES, synchronization will be performed based on the acquired reading history and the local reading history.

In a fifth possible embodiment based on any one of the foregoing possible embodiments, the synchronization based on the acquired reading history corresponding to the user account and the local reading history further includes:

merging the different reading history and the acquired reading history and uploading the merged reading history to the server, when the different reading history is located at the local reading history;

merging the different reading history and the local reading history, when the different reading history is located at the local reading history.

In a sixth possible embodiment based on any one of the foregoing possible embodiments, the synchronization based on the acquired reading history corresponding to the user account and the local reading history further includes:

determining whether the local reading history includes a modification operation to the reading history, if YES, the modification operation will be synchronized to the corresponding reading history of the server.

It can be appreciated by a person skilled in the art that all or parts of the steps of the above-mentioned embodiments can be implemented by hardware, firmware, software or any combination thereof. These programs can be stored in a computer readable storage medium, which may be a read only memory, a disk or an optical disk.

The disclosed embodiments are just some preferred embodiments of the disclosure, which are not intended to limit the disclosure. Any modifications, equivalents or improvements within the spirits and gist of the disclosure are within the scope of the disclosure.

What is claimed is:

1. A method for processing reading history, comprising:
receiving a reading history saving instruction, and acquiring an anchor position of a designated reading position of a current web page;
generating an anchor link, based on the anchor position of the designated reading position;
creating a reading history based on a title of the designated reading position and the anchor link, the created reading history comprises at least the title of the designated reading position and the anchor link; and
saving the created reading history.

2. The method according to claim 1, wherein, after creating a reading history based on a title of the designated reading position and the anchor link, the method comprising:
uploading the created reading history to a server such that the server performs synchronization based on the received reading history, when a user account is logged in.

3. The method according to claim 1, wherein, the method further comprising:
uploading the local reading history to the server, when a user account is logged in and it is determined that the user account initiates the reading history sync service for the first time;
acquiring the corresponding reading history of the user account saved by the server, when a user account is logged in and it is determined that the user account does not initiate the reading history sync service for the first time;
performing synchronization based on the acquired reading history corresponding to the user account and the local reading history.

4. The method according to claim 3, wherein, performing synchronization based on the acquired reading history corresponding to the user account and the local reading history comprises:
determining whether there is a difference between the local reading history and the acquired reading history, if YES, synchronization is performed based on the acquired reading history and the local reading history.

5. The method according to claim 4, wherein, the synchronization based on the acquired reading history corresponding to the user account and the local reading history comprises:
merging the different reading history and the acquired reading history, and uploading the merged reading history to the server, when the different reading history is located at the local reading history;
merging the different reading history and the local reading history, when the different reading history is located at the local reading history.

6. The method according to claim 4, wherein, the synchronization based on the acquired reading history corresponding to the user account and the local reading history comprises:
determining whether the local reading history comprises a modification operation to the reading history, if YES, the modification operation is synchronized to the corresponding reading history of the server.

7. An apparatus for processing reading history, comprising:
an anchor position acquisition module, configured to receive a reading history saving instruction, and acquire an anchor position of a designated reading position of a current web page;
a generation module, configured to generate an anchor link, based on the anchor position of the designated reading position;
a reading history creation module, configured to create a reading history based on a title of the designated reading position and the anchor link, the created reading history comprises at least the title of the designated reading position and the anchor link;
a saving module, configured to save the created reading history.

8. The apparatus according to claim 7, further comprising:
a first uploading module, configured to upload the created reading history to a server such that the server performs synchronization based on the received reading history, when a user account is logged in.

9. The apparatus according to claim 7, further comprising:
a second uploading module, configured to upload the local reading history to the server, when a user account is logged in and it is determined that the user account initiates the reading history sync service for the first time;
an acquisition module, configured to acquire the corresponding reading history of the user account saved by the server, when a user account is logged in and it is determined that the user account does not initiate the reading history sync service for the first time; and
a synchronization module, configured to perform synchronization based on the acquired reading history corresponding to the user account and the local reading history.

10. The apparatus according to claim 9, wherein the synchronization module comprises:
a determination unit, configured to determine whether there is a difference between the local reading history and the acquired reading history;
a synchronization unit, configured to perform synchronization based on the acquired reading history and the local reading history, when the determination unit determines that there is a difference between the local reading history and the acquired reading history.

11. The apparatus according to claim 10, wherein, the synchronization unit is configured to merge the different reading history and the acquired reading history, and upload the merged reading history to the server, when the different reading history is located at the local reading history;
the synchronization unit is also configured to merge the different reading history and the local reading history, when the different reading history is located at the local reading history.

12. The apparatus according to claim 9, wherein, the synchronization module is also configured to determine whether the local reading history comprises a modification operation to the reading history, if YES, the modification operation is synchronized to the corresponding reading history of the server.
